(19) United States
(12) Patent Application Publication
(10) Pub. No.: US 2023/0394386 A1
(43) Pub. Date: Dec. 7, 2023

(54) SYSTEM AND METHOD FOR CREATING PRODUCT COMPATIBILITY RULES FOR ENTERPRISE RESOURCE PLANNING SYSTEM

(71) Applicant: Caterpillar lnc., Peoria, IL (US)

(72) Inventors: Dinesh Kumar SIVASANKARAN, Walajapet (IN); Arulkumaran PALANI, Vellore (IN)

(73) Assignee: Caterpillar lnc,, Peoria, IL (US)

(21) Appl. No.: 18/206,333

(22) Filed: Jun. 6, 2023

(30) Foreign Application Priority Data
Jun. 6, 2022 (IN) 202211032263

(51) Int. Cl. G06Q 10/06

(52) U.S. Cl. CPC G06Q 10/06

(57) ABSTRACT

A method for creating product compatibility rules for an enterprise resource planning system. The method includes obtaining, by a processor, product compatibility rules defined for a plurality of products in a first standard format. The product compatibility rules define, for each product, a plurality of parameters and one or more configurations associated with each of the plurality of parameters which are at least one of compatible and non-compatible with the corresponding product. The method further includes generating, by the processor, a plurality of unique combinations of configurations for each product and identifying, by the processor, one or more products of the plurality of products for each unique combination of configurations. Further, the method includes creating, by the processor, product compatibility rules for the enterprise resource planning system by defining a relationship between the one or more products and each unique combination of configurations in a second standard format.

### TECHNICAL FIELD

The present disclosure relates to a method and a system for creating product compatibility rules for an enterprise resource planning system, for example, the SAP™ ERP (enterprise resource planning) system.

### BACKGROUND

Most businesses and/or dealers rely on product compatibility rules that define how different components can be constrained and used to customize and/or build a product. With most businesses and/or dealers utilizing enterprise resource planning (ERP) systems for other business processing functions, these product compatibility rules may be migrated to an ERP system.

United States Publication 2005/0144087 relates to a software system used to transfer sales data between two software modules having different data formats and data organizations. Entity objects containing executable code specified using metadata from a metadata database is used to process XML data representing data being transferred between the systems. These entity objects use metadata from the metadata database to define how data format transformations are to occur.

### SUMMARY

In one aspect, the present disclosure relates to a method for creating product compatibility rules for an enterprise resource planning system. The method includes obtaining, by a processor, product compatibility rules defined for a plurality of products in a first standard format. The product compatibility rules define, for each product, a plurality of parameters and one or more configurations associated with each of the plurality of parameters which are at least one of compatible and non-compatible with the corresponding product. The method further includes generating, by the processor, a plurality of unique combinations of configurations for each product by combining one configuration from each parameter of the plurality of parameters and identifying, by the processor, one or more products of the plurality of products for each unique combination of configurations. Further, the method includes creating product compatibility rules for the enterprise resource planning system by defining a relationship between the one or more products and each unique combination of configurations in a second standard format.

In another aspect, the present disclosure is directed to a system for creating product compatibility rules for an enterprise resource planning system. The system includes a memory and a processor communicatively coupled to the memory. The memory stores instructions executable by the processor, and wherein upon execution of the stored instructions the processor is configured to obtain product compatibility rules defined for a plurality of products in a first standard format. The product compatibility rules define, for each product, a plurality of parameters and one or more configurations associated with each of the plurality of parameters which are at least one of compatible and non-compatible with the corresponding product. The processor is further configured to generate a plurality of unique combinations of configurations for each product by combining one configuration from each parameter of the plurality of parameters and identify one or more products of the plurality of products for each unique combination of configurations. Further, the processor is configured to create product compatibility rules for the enterprise resource planning system by defining a relationship between the one or more products and each unique combination of configurations in a second standard format.

### BRIEF DESCRIPTION OF THE DRAWINGS

FIG. 1 is an environment implementing an exemplary system for creating product compatibility rules for an enterprise resource planning system, according to an embodiment of the present disclosure;

FIGS. 2-9 are examples explaining exemplary creation of the product compatibility rules for the enterprise resource planning system, according to an embodiment of the present disclosure; and

FIG. 10 is an exemplary method for creating the product compatibility rules for the enterprise resource planning system, according to an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

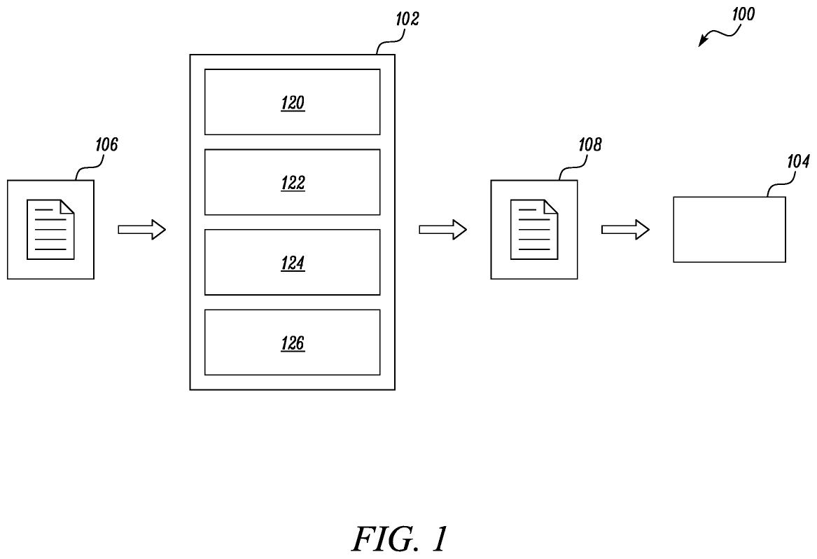

Referring to FIG. 1, an environment 100 implementing an exemplary system 102 is shown. The system 102 is configured to obtain product compatibility rules 106 defined in a first standard format and create product compatibility rules 108 in a second standard format for an enterprise resource planning system 104. The product compatibility rules 106, 108 correspond to a set of rules that defines a plurality of parameters and one or more configurations associated with each of the plurality of parameters compatible and/or non-compatible with a product. For example, the product may correspond to a machine component, such as but not limited to, tracks or track pairs usable in an undercarriage, internal combustion engines, and so on, for machines, such as construction machine, and the parameters may correspond to one or more features, type of components/sub-components, or parts associated with the machine component. The product compatibility rules 106, 108 define how different components can be constrained and used to customize and/or build a product.

The enterprise resource planning system 104 may be any system or a computing device employing an enterprise resource planning software that manages business activities such as product configuration or customization with other business processing functions, as known to persons skilled in the art. The enterprise resource planning system 104 is communicatively coupled to and communicate with the system 102 over a communication network. The communication network may include, but is not limited to, a wide area network (WAN) (for example, a transport control protocol/internet protocol based network) or a local area network (LAN) employing any of a variety of communications protocols as is now known or developed in the future.

In an embodiment, the system 102 and the enterprise resource planning system 104 may be integrated in one computing device incorporating the operations of the system 102 and the enterprise resource planning system 104. In such cases, the communication between the system 102 and the enterprise resource planning system 104 may happen via a cloud interface or a local interface, for example, using wired or wireless communication interfaces. In this disclosure, use of the term “local interface” may be regarded as being inclusive of data and/or power transfer interfaces, for example, buses, links or other wired or wireless connections commonly known to persons skilled in the art. The local interface may have additional elements such as controllers, buffers (caches), drivers, repeaters and receivers, among others, to enable communications. Further, the local interface may include address, control, and/or data connections to enable appropriate communications among various components.

In accordance with various embodiments, the system 102 is configured to create the product compatibility rules 108 for the enterprise resource planning system 104. The system 102 includes a plurality of electrical and electronic components, providing power, operational control, communication, and the like within the system 102. For example, the system 102 includes, among other components, a transceiver 120, an input/output unit 122, a processor 124, and a memory 126. It should be appreciated by those of ordinary skill in the art that FIG. 1 depicts the system 102 in a simplified manner and a practical embodiment may include additional components and suitably configured logic to support known or conventional operating features that are not described in detail herein. It will further be appreciated by those of ordinary skill in the art that the system 102 may be a personal computer, desktop computer, tablet, smartphone, or any other computing device now known or developed in the future.

Further, although the system 102 is shown and described to be implemented within a single computing device, it may be contemplated that the one or more components of the system 102 may alternatively be implemented in a distributed computing environment, without deviating from the scope of the claimed subject matter. It will further be appreciated by those of ordinary skill in the art that the system 102 alternatively may function within a remote server, cloud computing device, or any other remote computing mechanism, now known or developed in the future. The system 102 may be a cloud environment incorporating the operations of the transceiver 120, the input/output unit 122, the processor 124, and the memory 126, and various other operating modules to serve as a software as a service model for the enterprise resource planning system 104. The components of the system 102, including the transceiver 120, the input/output unit 122, the processor 124, and the memory 126 may communicate with one another via the local interface.

The transceiver 120 includes a transmitter circuitry and a receiver circuitry (not shown) to enable the system 102 to communicate with other systems or computing devices, such as the enterprise resource planning system 104. In this regard, the transmitter circuitry may include appropriate circuitry to transmit the product compatibility rules 108 in the second standard format to the enterprise resource planning system 104. Similarly, the receiver circuitry may include appropriate circuitry to receive the product compatibility rules 106 in the first standard format from one or more computing devices or systems (not shown). The transmitter circuitry and the receiver circuitry together form a wireless transceiver to enable wireless communication with one or more systems or computing devices, such as, the enterprise resource planning system 104. It will be appreciated by those of ordinary skill in the art that the system 102 may include a single transceiver 120 as shown, or alternatively separate transmitting and receiving components, for example but not limited to, a transmitter, a transmitting antenna, a receiver, and a receiving antenna.

The input/output unit 122 is configured to receive input from and/or to provide output to a user. The input may be provided via, for example, a keyboard, a touch screen display, a camera, a touch pad, a microphone, a recorder, a mouse, or any other user input mechanism now known or developed in the future. The output may be provided via a display device, speakers, or any other output mechanism, now known or developed in the future. The input/output unit 122 may further include, for example, a serial port, a parallel port, an infrared (IR) interface, a universal serial bus (USB) interface and/or any other interface herein known or developed in the future.

The memory 126 is a non-transitory memory configured to store a set of instructions that are executable by the processor 124 to perform the predetermined operations. For example, the memory 126 may include any of the volatile memory elements (for example, random access memory (RAM)), nonvolatile memory elements (for example read only memory (ROM)), and combinations thereof. Moreover, the memory 126 may incorporate electronic, magnetic, optical, and/or other types of storage media. In an embodiment, the memory 126 is configured to store the product compatibility rules 106 in the first standard format and the product compatibility rules 108 in the second standard format.

The processor 124 is configured to execute the instructions stored in the memory 126 to perform the predetermined operations, for example, the detailed functions of the system 102 as will be described hereinafter. The processor 124 may include one or more microprocessors, microcontrollers, DSPs (digital signal processors), state machines, logic circuitry, or any other device or devices that process information or signals based on operational or programming instructions. The processor 124 may be implemented using one or more controller technologies, such as Application Specific Integrated Circuit (ASIC), Reduced Instruction Set Computing (RISC) technology, Complex Instruction Set Computing (CISC) technology, or any other technology now known or in the future developed.

In operation, the processor 124 is configured to obtain the product compatibility rules 106 defined for a plurality of products in the first standard format. The processor 124 may obtain the product compatibility rules 106 in the first standard format from the memory 126 or another device, via the transceiver 120 or the user via the input/output unit 122. In accordance with various embodiments, the first standard format may correspond to any format in which, against each product, the plurality of parameters and one or more configurations associated with each of the plurality of parameters compatible and/or non-compatible with the product, are listed. In an embodiment, the product compatibility rules 106 in the first standard format may include one or more restrictive type statements to restrict the plurality of parameters and the one or more configurations with the product.

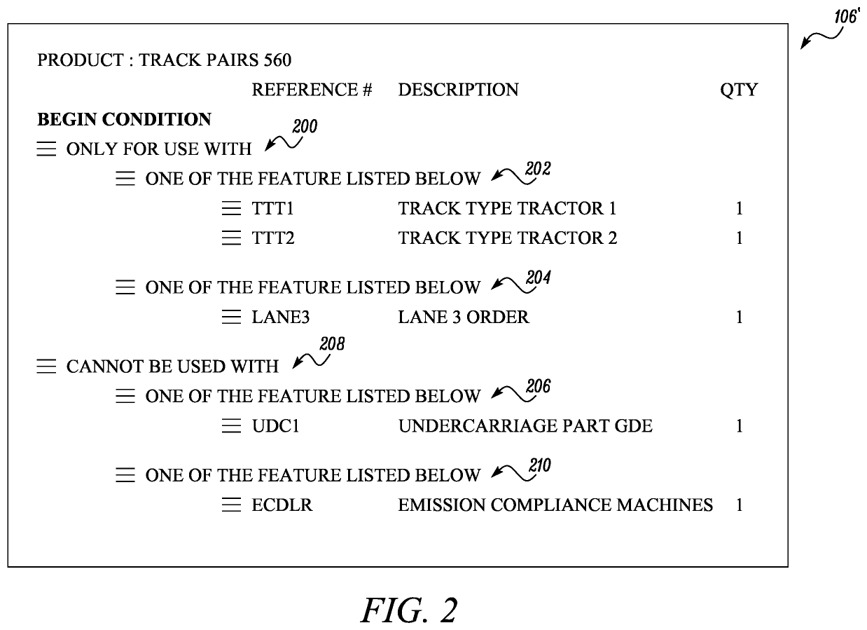

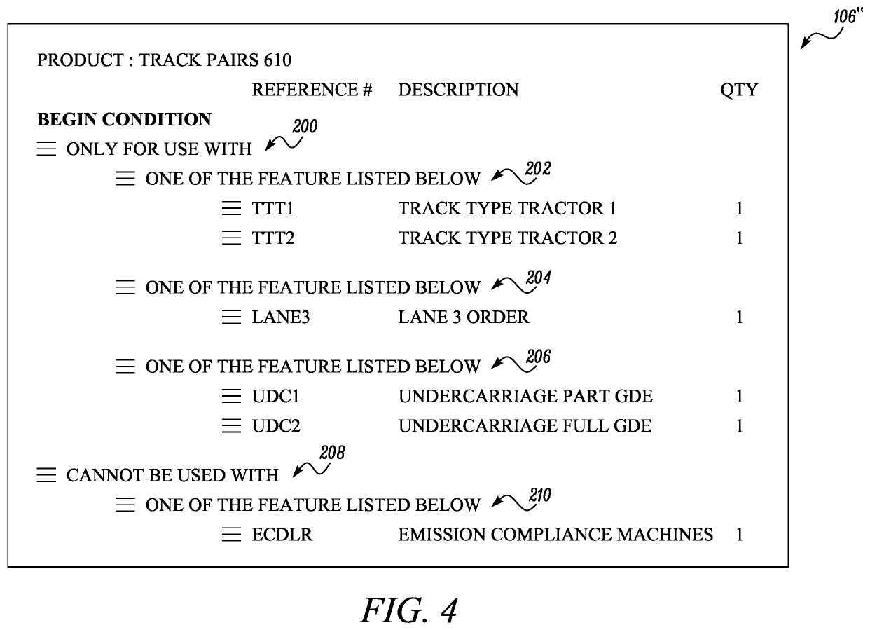

For example, FIGS. 2 and 4 show exemplary product compatibility rules 106′, 106″ for different products, such as, track pairs 560 and track pairs 610 in the first standard format. As shown in FIG. 2, the product compatibility rules 106′ defined in the first standard format include a first restrictive statement 200 listing the plurality of parameters, such as a machine type 202 and a lane order type 204, compatible with the track pairs 560. In an example, the lane order type 204 may correspond to a strategy for ordering products with different expected lead times. For instance, the lane 1 order may represent an express lane, featuring built-to-stock configuration choices at an expected lead time of a few days, while lane 3 order may represent an A-La-Carte Lane, built to order products with an expected lead time of a few months. In addition, one or more configurations, such as track type tractor 1 (referred to as TTT1) and track type tractor 2 (referred to as TTT2) associated with the machine type 202 and lane 3 order (referred to as LANE3) associated with the lane order type 204, compatible with the track pairs 560 are listed in the product compatibility rules 106′ defined in the first standard format.

Additionally, the product compatibility rules 106′ may also include a second restrictive statement 208 listing a plurality of parameters, such as an undercarriage type 206 and a dealer group type 210, that are non-compatible with the track pairs 560. The dealer group type 210 may correspond to a set of dealers that are grouped based on specific categories, such as countries, emission compliance, etc. For example, all dealers dealing with emission compliance machines may be grouped together and referred to as “ECDLR”. The one or more configurations, such as undercarriage part GDE (referred to as UDC1) associated with the undercarriage type 206 and emission compliance machines (referred to as ECDLR) associated with the dealer group type 210, non-compatible with the track pairs 560 are also listed in the product compatibility rules 106′ defined in the first standard format.

Similarly, as shown in FIG. 4, the product compatible rules 106″ defined in the first standard format include the first restrictive statement 200 listing the plurality of parameters, such as the machine type 202, the lane order type 204, and the undercarriage type 206 compatible with the track pairs 610. In addition, one or more configurations, such as track type tractor 1 (referred to as TTT1) and track type tractor 2 (referred to as TTT2) associated with the machine type 202, lane 3 order (referred to as LANE3) associated with the lane order type 204, and undercarriage part GDE (referred to as UDC1) and undercarriage full GDE (referred to as UDC2) associated with the undercarriage type 206, compatible with the track pairs 610 are also listed in the product compatibility rules 106″ defined in the first standard format.

Additionally, the product compatibility rules 106″ may also include the second restrictive statement 208 listing a plurality of parameters, such as the dealer group type 210 that are non-compatible with the track pairs 610. In addition, one or more configurations, such as emission compliance machines (referred to as ECDLR) associated with the dealer group type 210, non-compatible with the track pairs 610 are also listed in the product compatibility rules 106″ defined in the first standard format.

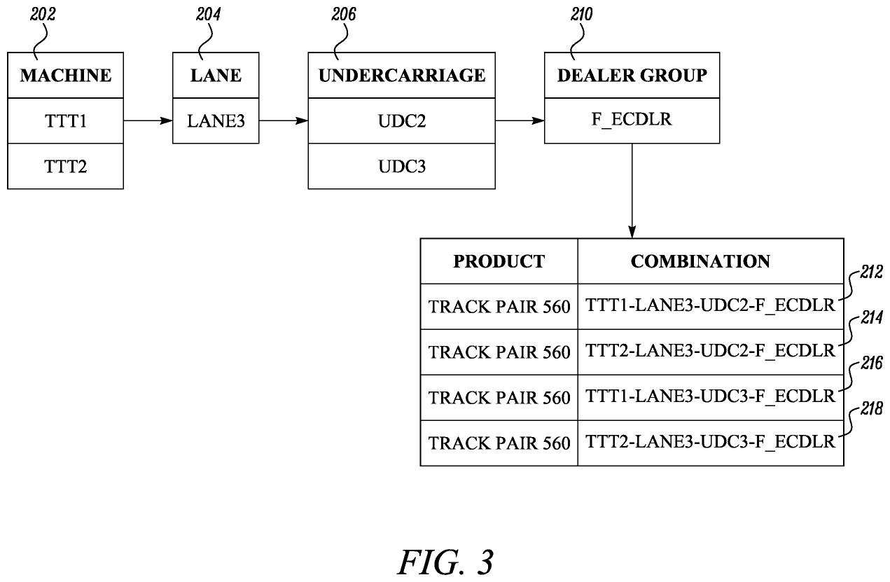

Referring back to FIG. 1, the processor 124 is configured to generate a plurality of unique combinations of configurations for each product. For example, the processor 124 may be configured to combine one configuration from each parameter of the plurality of parameters to generate the plurality of unique combinations. For example, as shown in FIG. 3, four (4) unique combinations 212, 214, 216, 218 can be generated for the track pairs 560. In some embodiments, the processor 124 is configured to convert each configuration that is non-compatible with the product (hereinafter referred to as a non-compatible configuration) to a configuration that is compatible with the product (hereinafter referred to as a compatible configuration). To this end, the processor 124 is configured to determine the parameter associated with the non-compatible configuration and identify the remaining configurations (other than the non-compatible configurations listed in the product compatibility rules 106) associated with the corresponding parameter as the compatible configurations associated with the product. For example, the non-compatible configuration UDC1 associated with the undercarriage type 206 (shown in FIG. 2) is converted to compatible configurations UDC2 and UDC3 (as shown in FIG. 3). In order to determine the compatible configurations UDC2 and UDC3, the processor 124 determines all configurations, such as UDC1, UDC2, and UDC3, associated with the undercarriage type 206 and identifies the remaining configurations (i.e., UDC2 and UDC3) as the compatible configurations associated with the track pairs 560. In accordance with various embodiments, the processor 124 is configured to convert a non-compatible configuration to a compatible configuration when a number of configurations associated with the corresponding parameter is less than a predefined threshold number.

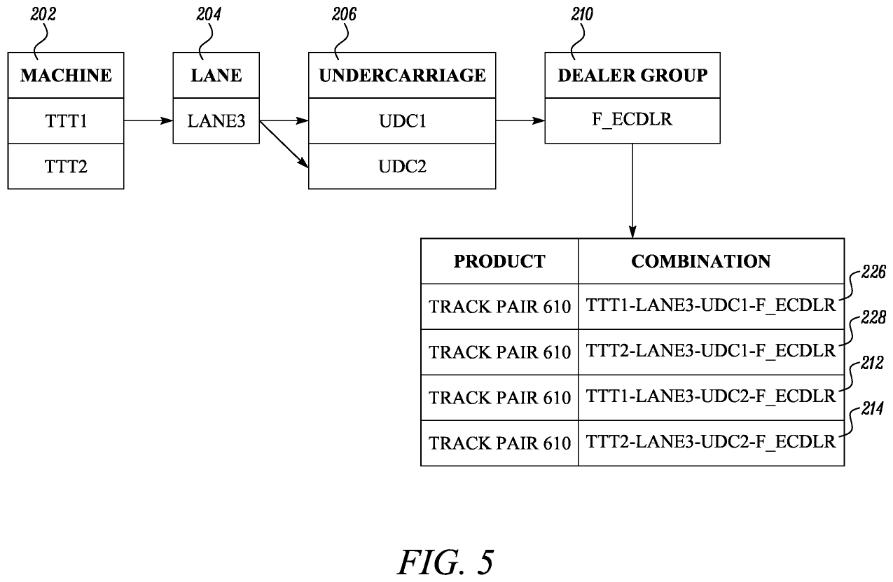

In some embodiments, the processor 124 is configured to identify the one or more non-compatible configurations as negative conditions, for example, by adding a prefix ‘F’ denoting configuration in a negative condition. For example, as shown in FIGS. 3 and 5, the non-compatible configuration ECDLR associated with the dealer group type 210 may be identified and prefixed with a symbol ‘F’ to denote the configuration in a negative condition. In accordance with various embodiments, the processor 124 is configured to identify the one or more non-compatible configurations as negative conditions when a number of configurations associated with the corresponding parameter is greater than or equal to a predefined threshold number.

The processor 124 is further configured to generate a plurality of unique combinations. As illustrated in FIG. 3, the unique combination 212 is generated by combining the track type tractor 1 (referred to as TTT1) associated with the machine type 202, the lane 3 order (referred to as LANE3) associated with the lane order type 204, the undercarriage full GDE (referred to as UDC2) associated with the undercarriage type 206, and the emission compliance machines in the negative condition (referred to as F_ECDLR) associated with the dealer group type 210. Similarly, the unique combination 214 is generated by combining the track type tractor 2 (referred to as TTT2) associated with the machine type 202, the lane 3 order (referred to as LANE3) associated with the lane order type 204, the undercarriage full GDE (referred to as UDC2) associated with the undercarriage type 206, and the emission compliance machines in the negative condition (referred to as F_ECDLR) associated with the dealer group type 210. Similarly, the unique combination 216 is generated by combining the track type tractor 1 (referred to as TTT1) associated with the machine type 202, the lane 3 order (referred to as LANE3) associated with the lane order type 204, the undercarriage CTR (referred to as UDC3) associated with the undercarriage type 206, and the emission compliance machines in the negative condition (referred to as F_ECDLR) associated with the dealer group type 210. Similarly, the unique combination 218 is generated by combining the track type tractor 2 (referred to as TTT2) associated with the machine type 202, the lane 3 order (referred to as LANE3) associated with the lane order type 204, the undercarriage CTR (referred to as UDC3) associated with the undercarriage type 206, and the emission compliance machines in the negative condition (referred to as F_ECDLR) associated with the dealer group type 210.

Similarly, four (4) unique combinations 226, 228, 212, 214 are generated for the track pairs 610, as illustrated in FIG. 5. The unique combination 226 is generated by combining the track type tractor 1 (referred to as TTT1) associated with the machine type 202, the lane 3 order (referred to as LANE3) associated with the lane order type 204, the undercarriage part GDE (referred to as UDC1) associated with the undercarriage type 206, and the emission compliance machines in the negative condition (referred to as F_ECDLR) associated with the dealer group type 210. The unique combination 228 is generated by combining the track type tractor 2 (referred to as TTT2) associated with the machine type 202, the lane 3 order (referred to as LANE3) associated with the lane order type 204, the undercarriage part GDE (referred to as UDC1) associated with the undercarriage type 206, and the emission compliance machines in the negative condition (referred to as F_ECDLR) associated with the dealer group type 210. The unique combination 212 is generated by combining the track type tractor 1 (referred to as TTT1) associated with the machine type 202, the lane 3 order (referred to as LANE3) associated with the lane order type 204, the undercarriage full GDE (referred to as UDC2) associated with the undercarriage type 206, and the emission compliance machines in the negative condition (referred to as F_ECDLR) associated with the dealer group type 210. Similarly, the unique combination 214 is generated by combining the track type tractor 2 (referred to as TTT2) associated with the machine type 202, the lane 3 order (referred to as LANE3) associated with the lane order type 204, the undercarriage full GDE (referred to as UDC2) associated with the undercarriage type 206, and the emission compliance machines in the negative condition (referred to as F_ECDLR) associated with the dealer group type 210.

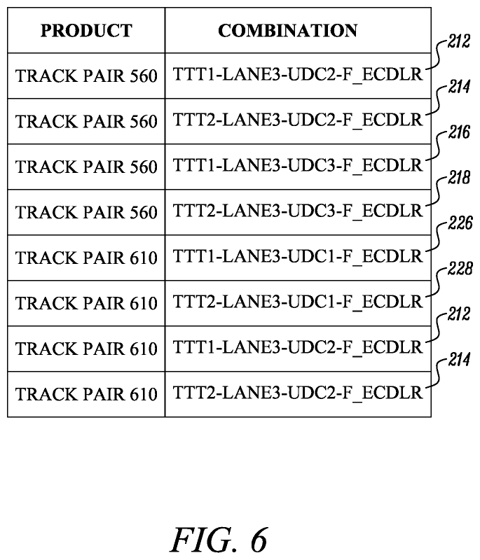

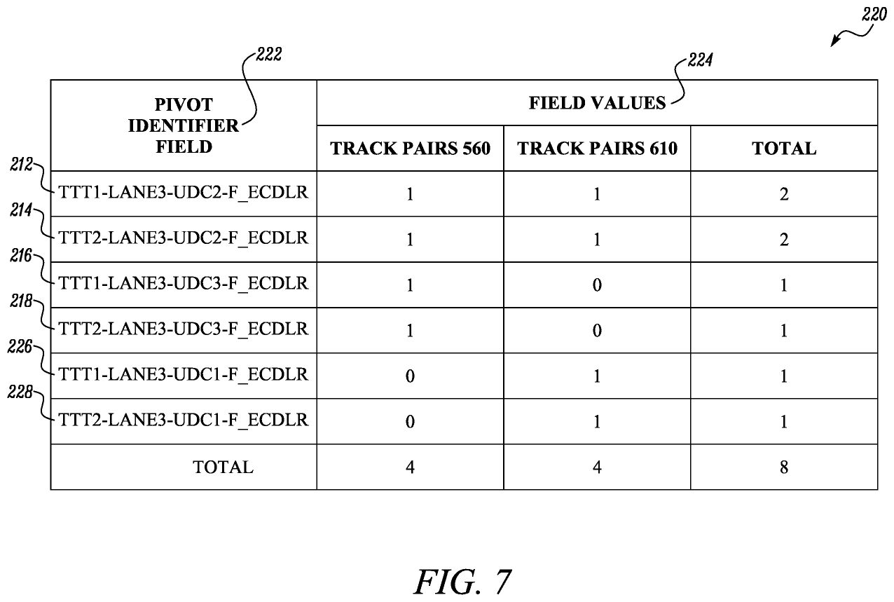

Referring back to FIG. 1, the processor 124 is configured to identify one or more products of the plurality of products for each unique combination of configurations. To this end, the processor 124 is first configured to combine the plurality of unique combinations generated for each of the plurality of products. For example, as shown in FIG. 6, the plurality of unique combinations 212, 214, 216, 218, 226, and 228 generated for the track pairs 560 and the track pairs 610 are combined. The processor 124 is further configured to identify one or more products of the plurality of products for each unique combination of configurations by identifying the plurality of unique combinations (for example, as a pivot identifier field) and determining field values associated with the plurality of products for each unique combination. For example, as shown in FIG. 7, a pivot table 220 is created by identifying the plurality of unique combinations 212, 214, 216, 218, 226, and 228 as the pivot identifier field 222. As illustrated in FIG. 7, the products, such as the track pairs 560 and the track pairs 610 corresponding to each unique combinations 212, 214, 216, 218, 226, and 228 are identified by determining field values 224 associated with the track pairs 560 and the track pairs 610 for each unique combination 212, 214, 216, 218, 226, and 228.

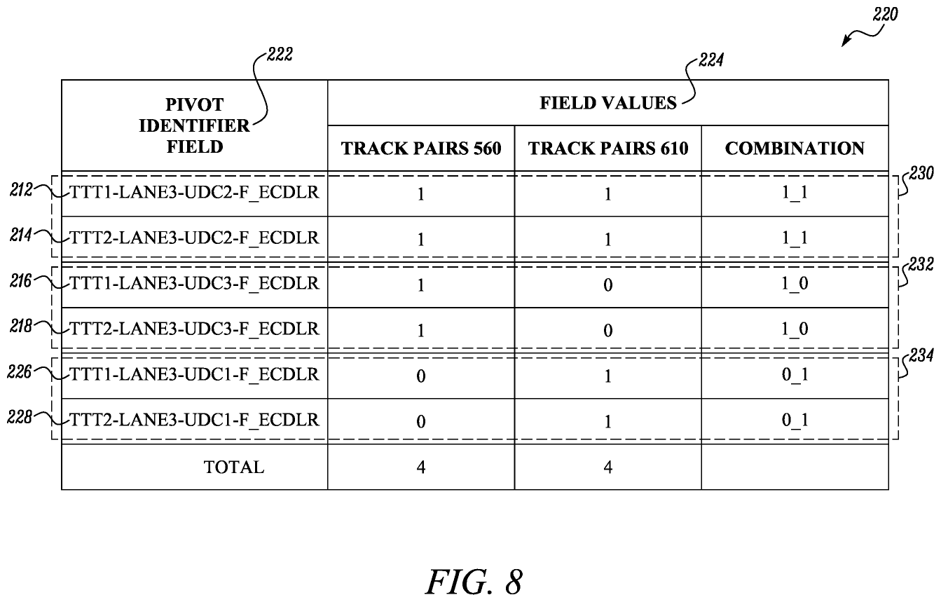

The processor 124 is configured to create product compatibility rules 108 for the enterprise resource planning system 104 by defining a relationship between the one or more products and each unique combination of configurations in the second standard format. To this end, the processor 124 is configured to first group the one or more products based on the unique combination of configurations. In accordance with various embodiments, the grouping may be performed based on the compatibility or non-compatibility of the unique combination of configurations with the one or more products. For example, a first group may be formed including the unique combinations of configurations that are compatible with each one of the plurality of products. As shown in FIG. 8, a first group 230 is formed having the unique combinations 212 and 214 compatible with both the track pairs 560 and the track pairs 610. Similarly, other groups may be formed including the unique combinations of configurations that are compatible with only one of the plurality of products. As shown in FIG. 8, a second group 232 is formed having the unique combination 216 and 218 compatible with only the track pairs 560. Similarly, a third group 234 is formed having the unique combination 226 and 228 compatible with only the track pairs 610.

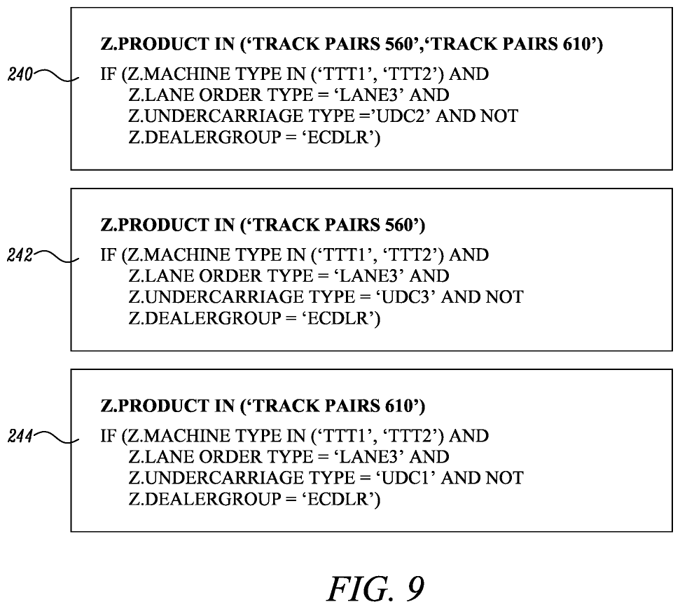

The processor 124 is then configured to define, for each group, the relationship between the one or more products and each unique combination of configurations in a second standard format. In accordance with various embodiments, the second standard format corresponds to a variant configuration in a format associated with the enterprise resource planning system 104. In an exemplary embodiment, the variant configuration associated with the enterprise resource planning system 104 is defined using AND and/or OR and/or NOT relationship. For example, as shown in FIG. 9, the relationship 240 between the products, such as, the track pairs 560 and the track pairs 610, and the unique combination 212 and 214 associated with the track pairs 560 and the track pairs 610 in the first group 230 is defined using AND, NOT, and OR (referred to as “,”) relationship. Similarly, the relationship 242 between the product, such as, the track pairs 560, and the unique combinations 216 and 218 associated with the track pairs 560 in the second group 232 is defined using AND, NOT, and OR (referred to as “,”) relationship. Similarly, the relationship 244 between the product, such as, the track pairs 610, and the unique combinations 226 and 228 associated with the track pairs 610 in the third group 234 is defined using AND, NOT, and OR (referred to as “,”) relationship. In accordance with various embodiments, the NOT relationship is used for the one or more non-compatible configurations defined as negative conditions. The processor 124 is further configured to provide the created product compatibility rules 108 in the second standard format to the enterprise resource planning system 104.

### INDUSTRIAL APPLICABILITY

With most businesses and/or dealers utilizing enterprise resource planning systems 104 for other business processing functions, it becomes important to migrate or create the product compatibility rules in the enterprise resource planning system 104 to integrate the product configuration function with the other business processing functions in a single enterprise-wide system. However, migration or creation of the product compatibility rules in the enterprise resource planning system is a manual process that is time-consuming and prone to errors.

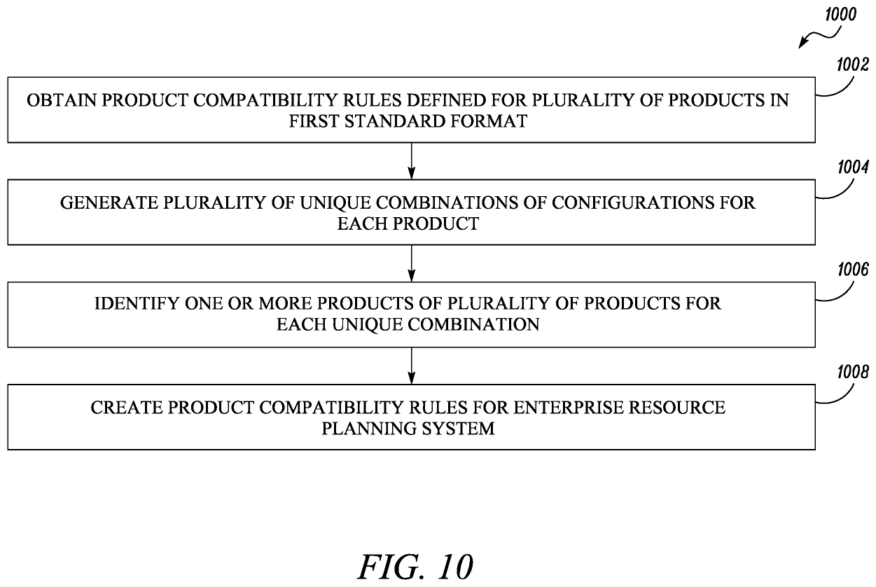

FIG. 10 shows a method 1000 for creating product compatibility rules 108 for an enterprise resource planning system 104, in accordance with an embodiment of the present disclosure. At step 1002, the processor 124 obtains the product compatibility rules 106 defined for the plurality of products in the first standard format. The processor 124, at step 1004, generates the plurality of unique combinations of configurations for each product by combining one configuration from each parameter of the plurality of parameters. At step 1006, the processor 124 identifies the one or more products of the plurality of products for each unique combination of configurations. Further, at step 1008, the processor 124 creates the product compatibility rules 108 for the enterprise resource planning system 104 by defining the relationship between the one or more products and each unique combination of configurations in the second standard format.

Implementation and use of the method 1000 and system 102 of the present disclosure enable the automatic creation of the product compatibility rules 108 for the enterprise resource planning system 104. The creation of the product compatibility rules 108, in the present disclosure, provides quick and reliable results that are free from any errors. This saves the time required to manually create and test the product compatibility rules for the enterprise resource planning system 104.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A method for creating product compatibility rules for an enterprise resource planning system, the method comprising:
obtaining, by a processor, product compatibility rules defined for a plurality of products in a first standard format, wherein the product compatibility rules define, for each product, a plurality of parameters and one or more configurations associated with each of the plurality of parameters which are at least one of compatible and non-compatible with the corresponding product;
generating, by the processor, a plurality of unique combinations of configurations for each product by combining one configuration from each parameter of the plurality of parameters;
identifying, by the processor, one or more products of the plurality of products for each unique combination of configurations; and
creating, by the processor, product compatibility rules for the enterprise resource planning system by defining a relationship between the one or more products and each unique combination of configurations in a second standard format.

2. The method as claimed in claim 1, wherein the product includes a machine component, and the parameters include one or more of features, components, or parts associated with the machine component.

3. The method as claimed in claim 1, wherein identifying one or more products of the plurality of products for each unique combination of configurations includes identifying the plurality of unique combinations as a pivot identifier field and determining field values associated with the plurality of products for each unique combination.

4. The method as claimed in claim 1, wherein the second standard format includes variant configuration associated with the enterprise resource planning system.

5. The method as claimed in claim 4, wherein the variant configuration associated with the enterprise resource planning system is defined using one or more of AND, OR, and NOT relationship.

6. The method as claimed in claim 1, wherein creating the product compatibility rules includes grouping, by the processor, the one or more products based on the unique combination of configurations.

7. A system for creating product compatibility rules for an enterprise resource planning system, the system comprising:
a memory; and
a processor communicatively coupled to the memory, wherein the memory stores instructions executable by the processor, and wherein upon execution of the stored instructions the processor is configured to:
obtain product compatibility rules defined for a plurality of products in a first standard format, wherein the product compatibility rules define, for each product, a plurality of parameters and one or more configurations associated with each of the plurality of parameters which are at least one of compatible and non-compatible with the corresponding product;
generate a plurality of unique combinations of configurations for each product by combining one configuration from each parameter of the plurality of parameters;
identify one or more products of the plurality of products for each unique combination of configurations; and
create product compatibility rules for the enterprise resource planning system by defining a relationship between the one or more products and each unique combination of configurations in a second standard format.

8. The system as claimed in claim 7, wherein the product includes a machine component, and the parameters include one or more of features, components, or parts associated with the machine component.

9. The system as claimed in claim 7, wherein the processor is configured to identify one or more products of the plurality of products for each unique combination of configurations by identifying the plurality of unique combinations as a pivot identifier field and determining field values associated with the plurality of products for each unique combination.

10. The system as claimed in claim 7, wherein the second standard format includes variant configuration associated with the enterprise resource planning system.
